(19) United States
(12) Patent Application Publication
(10) Pub. No.: US 2003/0110090 A1
(43) Pub. Date: Jun. 12, 2003

(54) Method for selecting goods/services in trade mark transaction processing

(76) Inventors: Robert Benjamin Franks, Bolsterstone (GB); Martin Neilson, Huddersfield (GB)

Correspondence Address: HARNESS, DICKEY & PIERCE, P.L.C., P.O. BOX 828, BLOOMFIELD HILLS, MI, 48303, US

(21) Appl. No.: 10/030,844

(22) PCT Filed: May 8, 2001
(86) PCT No.: PCT/GB01/01974

(30) Foreign Application Priority Data
May 11, 2000 (GB) 0011245.8
Jul. 14, 2000 (GB) 0017217.1

(51) Int. Cl. G06F 17/60

(52) U.S. Cl. 705/26

(57) ABSTRACT

The invention comprises a tool usable by a user of an electronic commerce system capable of handling transactions concerning the filing and registration of trade mark application. The tool is configured to allow a user of the system to select goods/services to be included in the online trade mark application.

### FIELD OF THE INVENTION

The present invention relates to the field of electronic commerce systems capable of handling transactions concerning the filing and registration of trade mark applications, such that the present invention allows a user to select the goods/services to be included in the application from a predetermined list.

### BACKGROUND OF THE INVENTION

Historically, trade mark rights have been allocated according to local or national laws by a process of registering trade mark applications at governmental or intergovernmental bodies. Historically, transactions have been via a paper-based application process involving the filling in of paper application forms which are then sent by surface mail or by facsimile to a governmental office by a trade mark agent or trade mark attorney. However, the current state of the art methods for filing trade mark applications are somewhat non-user friendly and require a user to spend a large amount of time completing an application form. State of the art on-line trade mark application systems often require a user to input characters directly into a text box. This is often a requirement of the user when state of the art on-line trade mark application systems require information concerning the trade mark and, in particular, the goods/services to which the trade mark will be associated.

The inputting of characters relating to the trade mark details into a suitable text box is a relatively non-time consuming exercise, as trade marks generally do not comprise more than a few words. However, the specification of goods/services to which the trade mark is to be associated, being a requirement of the application, may involve a considerably large number of words. For example, if a user of the on-line application system desires to register a trade mark for a large number of goods and/or services, the user may be required to manually type, for example, over 500 words within a suitable text box.

There are several drawbacks in this method of inputting goods/services. These include, for example, the increased amount of time spent on-line, while filling in the trade mark application form, thereby increasing the cost, of for example the telephone bill. Also, it is not uncommon for typing errors to occur when specifying the goods/services of a trade mark application. Additionally, it is not uncommon for misspelled words to be inputted by a user whilst completing the on-line trade mark application form. The inclusion of typing errors and misspelled words create problems at later stages in the trade mark application procedure, requiring the expenditure of time and money to correct.

An additional problem associated with a user committing considerable amount of time and effort into typing the specification of goods/services into a text box, is that if, for some reason, connection between the user terminal and the host terminal is lost, the time and effort already expended by the user in typing the goods/services will have been unfruitful.

It is also perceivable that users, when confronted with the prospect of having to type in, the entire specification of goods/services to which their mark will be associated, simply do not want to, or cannot, afford the time often resulting, in the user not pursuing the on-line trade mark application route and opting instead for the more conventional procedure of instructing a firm of trade mark agents to file the trade mark application.

Therefore, it is highly likely that the problem of manually typing in the specification of goods/services, forming part of the trade mark application, is responsible for many applicants not wishing to file trade mark applications using the state of the art on-line trade mark application systems.

What is required is an electronic commerce system capable of handling transactions concerning the filing of trade mark applications that allows a user to specify the goods/services to be associated with the trade mark with considerable ease, and without the need for the user to input large numbers of characters into a text box.

It is desirable to have an electronic commerce system for the filing of trade mark applications on-line, that presents the user with a predetermined list of goods/services from which he/she may select the appropriate goods/services relating to his/her own particular trade mark.

An electronic commerce system capable of handling on-line trade mark applications such that the user is presented with a predetermined list of goods/services is described herein. Moreover, the method of presenting and selecting goods/services is described in detail.

### SUMMARY OF THE INVENTION

The invention comprises a tool usable by a user of an electronic commerce system capable of handling transactions concerning the filing and registration of trade mark applications. The tool is configured to allow a user of the system to select goods/services to be included in the online trade mark application.

Specific embodiments of the invention seek to replace more conventional electronic commerce systems involving filing and registration of trade mark applications. The embodiments also seek to replace the need for the user to type in extensively, words which relate to the goods/services. Embodiments described herein provide a system that presents a predetermined list of goods/services to a user and then allows the user to select the goods/services from the predetermined list.

Further specific implementations according to the present invention seek to remove the considerable time delay associated with more conventional systems of filing and registering trade mark applications.

According to one aspect of the present invention there is provided an internet based system configurable to allow a user to file at least one trade mark application at at least one International Office comprising:

means for presenting a predetermined list of goods/services to said user of said service system; and

means for selecting said goods/services from said predetermined list.

Said means for presenting said goods/services may comprise use of at least one drop down menu.

Said means for presenting said goods/services may comprise use of at least one scroll bar window.

Said means for selecting said goods/services may comprise use of at least one icon, whereby said user of said system selects said goods/services via selection of said icon.

Said means for selecting said goods/services may comprise use of at least one box, whereby said user of said system selects said goods/services via selection of said box.

Said means for selecting said goods/services may comprise use of at least one text box, whereby said user of said system selects said goods/services via the entry of characters into said text box.

Said means for selecting said goods/services may comprise highlighting, whereby said user of said system selects said goods/services by highlighting said goods/services.

Said means for selecting said goods/services may comprise underlining means, whereby said user of said system selects said goods/services by underlining said goods/services.

According to another aspect of the present invention there is provided a method of presenting and selecting goods/services; said goods/services forming part of a trade mark application, said trade mark application being made via an internet based system; comprising the steps of:

presenting a predetermined list of said goods/services to a user of said system; selecting said goods/services from said predetermined list.

The method may further comprise the steps of:

present said predetermined list of said goods/services as:

class headings; and

additional words.

The method may further comprise the steps of:

presenting said predetermined list of said goods/services using at least one drop down menu.

The method may further comprise the steps of:

presenting said predetermined list of said goods/services using at least one scroll bar window.

The method may further comprise the steps of:

selecting said goods/services from said predetermined list using:

at least one icon; or

at least one box; or

at least one text box.

The method may further comprise the steps of:

selecting said goods/services from said predetermined list by way of highlighting said goods/services; or

underlining said goods/services.

Said method may further comprise the steps of:

presenting said goods/services as class headings using a scrollbar window;

selecting said goods/services;

entering additional words within a suitable text box.

Said method may further comprise the steps of:

presenting said goods/services as class headings using a suitable scrollbar window;

presenting additional words to said user of said system using a scrollbar window;

selecting said additional words by highlighting said additional words.

The method may further comprise the steps of:

presenting said goods/services as class headings using a scrollbar window;

presenting additional words of said goods/services using a scrollbar window;

selecting said class headings and said additional words by highlighting said class headings and said additional words.

The method may further comprise the steps of:

presenting said goods/services as class headings using a first scrollbar window;

presenting additional words of said goods/services using a second scrollbar window, said second scrollbar window being generated from said first scrollbar window.

The method may further comprise the steps of:

sorting said goods/services into the relevant classes following the presenting and selecting of said goods/services.

The method may further comprise the steps of:

specifying a country in which said trade mark application will be filed;

presenting said goods/services as class headings using a first scrollbar window;

presenting additional words of said goods/services using a second scrollbar window;

said presenting of said goods/services being in the official language of said country in which said trade mark application will be filed.

According to third aspect of the present invention there is provided a user interface for generating an interactive display capable of receiving instructions for selection of individual goods/services, said user interface comprising:

a plurality of class selection icons for selecting at least one class of goods/services;

wherein said user interface is capable of receiving said instructions by selection of a said class selection icon.

The user interface may further comprise:

at least one dialogue box for containing a list of individual goods/services by name,

wherein said user interface is capable of receiving said instructions by activation of individual text data within said text dialogue box.

The user interface may further comprise a dialogue box data entry display, for entering text descriptions of goods/services not listed in said goods/services menu.

Said menu dialogue preferably lists a generic text description of goods/services corresponding to a class icon.

The user interface may further comprise:

a country selection icon capable of receiving instructions for selecting a country wherein,

upon entering a country code corresponding to a particular country, said goods/services are displayed in a language appropriate to said selected country.

The invention includes a remotely accessible user interface for generating an interactive display capable of receiving instructions for selection of individual goods/services, said user interface comprising:

at least one data processor,

at least one memory storing instructions for operating said data processor;

at least one memory for storing data describing a plurality of individual countries, and text descriptions of classifications of goods/services;

said user interface configured to display:

a plurality of class selection icons for selecting at least one class of goods/services;

a menu display, listing a generic text description of goods/services corresponding to a said class icon.

at least one dialogue box display for entering text descriptions of goods/services;

wherein said user interface is capable of receiving instructions for selection of at least one class of goods/services by activating a said icon selecting said at least one class of goods/services.

According to a fourth aspect of the present invention there is provided a method of operation of a user interface for receiving instructions for selection of individual goods/services, said method comprising:

generating an interactive display of a plurality of class icons, each representing a class of goods/services;

selecting at least one class of goods/services by activating at least ine said class selection icon.

Said method may further comprise the steps of:

generating at least one text menu dialogue box containing a list of individual goods/services by name; and

receiving said instructions by activation of individual text data within said text dialogue box.

Said menu dialogue may list a generic text description of goods/services corresponding to a class icon.

Said method may further comprise the steps of:

generating a dialogue box data entry display, for entering text descriptions of goods/services not listed in said goods/services menu.

Said method may further comprise the steps of:

generating selection icon capable of receiving instructions for selecting a country,

receiving instructions for selecting a country, by selection of said country selection icon; and

upon entering a country code corresponding to a particular country, displaying said goods/services in a language appropriate to said selected country.

The invention includes a method of operation of a remotely accessible user interface for generating an interactive display capable of receiving instructions for selection of individual goods/services, said user interface comprising:

at least one data processor,

at least one memory storing instructions for operating said data processor; and

at least one memory for storing data describing a plurality of individual countries, and text descriptions of classifications of goods/services;

said method comprising the steps of:

displaying a plurality of class selection icons for selecting at least one class of goods/services;

displaying a menu dialogue, listing a generic text description of goods/services corresponding to a said class selection icon;

displaying at least one dialogue box display for entering text descriptions of goods/services;

receiving instructions for selection of at least one class of goods/services by activating a said class selection icon selecting said at least one class of goods/services; and

receiving instructions for selection of individual goods/services by receiving text descriptions of said goods/services entered via a said dialogue box display for entering text.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically an overview of a service system for serving a plurality of customers for the purpose of filing registered trade mark applications;

FIG. 2 illustrates schematically individual machine components comprising the service system of FIG. 1 herein;

FIG. 3 illustrates schematically individual components of a client platform according to a specific implementation of the present invention;

FIG. 4 illustrates schematically a data signal received by the client platform from a server platform;

FIG. 5 illustrates schematically a data flow diagram detailing the operation of the service system and now the selecting of the goods/services, forms and integral part of the on-line trade mark application procedure.

FIG. 6 illustrates schematically a view of a homepage visual display at the server platform, viewable by a customer terminal using a web browser;

FIG. 7 illustrates schematically an order form page display at the server platform, viewable by a web browser at a customer terminal;

FIG. 8 illustrates schematically a law page display at the server platform, viewable by a web browser at a customer terminal;

FIG. 9 illustrates schematically a registration process page display at the server platform, viewable by a web browser at a customer terminal;

FIG. 10 illustrates schematically a mode of operation of the server platform allowing a user to select goods/services;

FIG. 11 illustrates schematically a method by which goods/services are presented and selected by a user;

FIG. 12 illustrates schematically a particular embodiment of the present invention which allows a user to select the goods/services from a predetermined list of goods/services;

FIG. 13 illustrates schematically a second embodiment of the present invention which allows a user to select the goods/services from a predetermined list of goods/services;

FIG. 14 illustrates schematically a third embodiment of the present invention which allows a user to select the goods/services from a predetermined list of goods/services;

FIG. 15 illustrates schematically a fourth embodiment of the present invention which allows a user to select the goods/services from a predetermined list of goods/services;

FIG. 16 illustrates schematically one embodiment of the present invention which provides a method of sorting selected goods/services inputted by a user into the correct classification of goods/services;

FIG. 17 illustrates schematically a second embodiment of the present invention which provides a method of sorting selected goods/services inputted by a user into the correct classification of goods/services;

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification, the term ‘personal computer’ refers to any device having data processing capability, capability to communicate with other computer entities, and the user interface having a visual display, and includes computers which comply with standard PC format, Macintosh®, Macintosh Racer Trade Mark Devices, Psion palmtop devices, laptop computers and mobile phones operating under the known wireless access protocol (WAP).

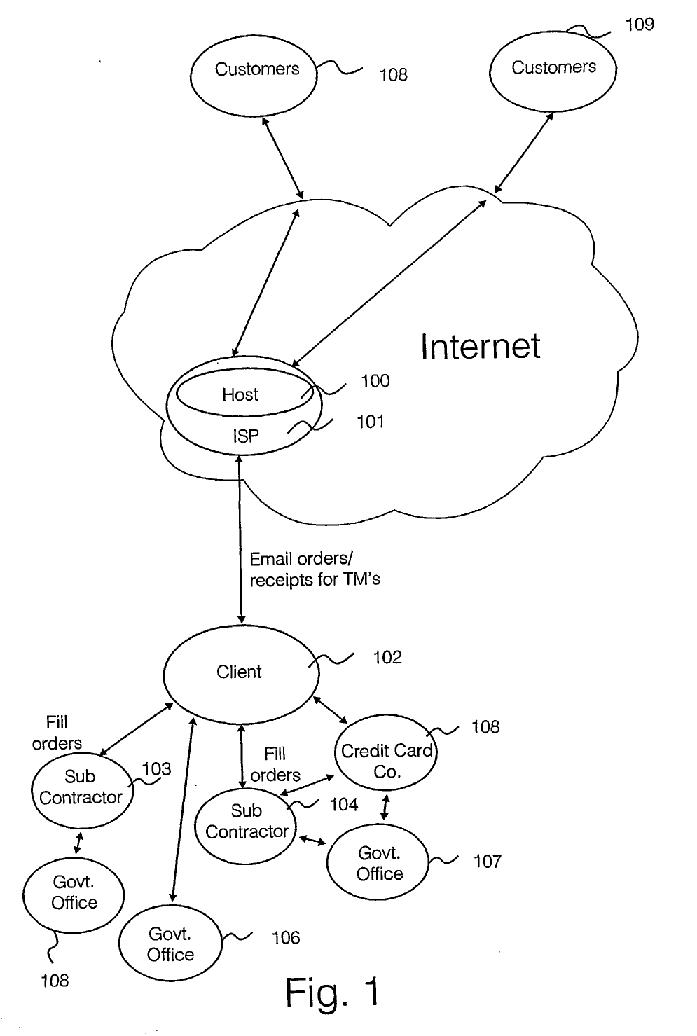

Referring to FIG. 1 herein, there is illustrated schematically a system of cooperating computer entities for providing automated filing of registered trade mark applications at a plurality of governmental or intergovernmental trade mark offices from a plurality of remote locations. The system comprises a host server computer apparatus 100, for example residing at an internet service provider body 101; a client terminal computer apparatus 102 in communication with the host server 100 via a dedicated line, for example an ISDN line, or via a virtual private network (VPN), or via the internet; a plurality of sub-contractor terminals 103, 104, communicating with the client terminal 102 and/or the host server 100 via the internet, via one or more VPNs or via one or more ISDN lines; the client terminal 102 and each sub-contractor terminal 103, 104 communicating via the internet, via one or more VPNs, or via one or more ISDN lines with a plurality of governmental or intergovernmental terminals 105-107; one or more finance company servers 108 communicating with one or more client terminals 102, one or more subcontractor terminals 104 and/or one or more government office servers 107 via the internet, a VPN or one or more ISDN lines; and a plurality of customer terminals 108, 109, each capable of communicating with the host server 100 via the internet, a VPN, or one or more ISDN lines: and a search agent 110 which may also be accessed via the internet, a VPN or similar.

It will be understood in the general sense that each of a plurality of logical entities of a customer terminal, host server, internet service provider, client terminal, sub-contractor terminal, government or intergovernmental office server or finance company server may be interconnected with each other through any suitable communication medium, including the internet, a virtual private network, one or more land lines, for example ISDN lines, or through wireless links.

In overview, operation of the system is as follows. A plurality of individual customers for trade mark registration have customer terminals 108, 109. In the best mode, customer terminals are conventional personal computers or the like, having a web browser and having access to the internet. Customers find the host server 100 using a direct connection or via a known search engine, e.g. Yahoo®, Alta Vista®, Lycos®, Web Top®, or the like. The host server 100 presents an interactive web site display to each customer terminal 108, 109 simultaneously and in parallel which is accessed by means of a human web browser located at each customer terminal. Through the web site customers can make data entries at the customer terminals of information required for filing a registered trade mark application as is described hereafter. The information is collected as digital data by the host server, which upon receipt of a ‘proceed’ signal from a customer terminal sends a confirmation message back to the customer terminal that a trade mark application has been instructed to be applied to registered.

The host server 100 forwards details of the application and the instruction to a client terminal 102 which may reside at a remote location from the host server. The client terminal 102 processes the relevant trade mark application data and forwards trade mark application instruction data to one or a plurality of sub-contractor terminals 103 and/or one of a plurality of government office servers 105-107 for implementing the filing of a trade mark application, and to finance server 108 for collection of payment.

In the case of trade mark application instruction data sent by the client terminal to a government office server, the government office server may return official confirmation data back to the client terminal. The client terminal may then relay the official confirmation data via the host server 100 to instructing the customer at the customer terminal 108, 109 or to any other customer terminal specified by the customer.

The client terminal 102 may also send trade mark application instruction data to one of the sub-contractor terminals 103 which may then forward it to a government office server 105-107. In this case, a government office server may return official confirmation data via a said sub-contractor terminal 103 to the client terminal 102, which relays the official confirmation data via the host server 100 and back to a customer terminal 108, 109.

In a best mode implementation, data is transferred and processed electronically at the customer terminal, the host server 100, the client terminal 102, each sub-contractor terminal 104, and each government office server 105-107, as well as at the finance company server 108. In the best mode implementation, data may be passed automatically between individual computer terminal and server entities in the system, without the need for human user interaction.

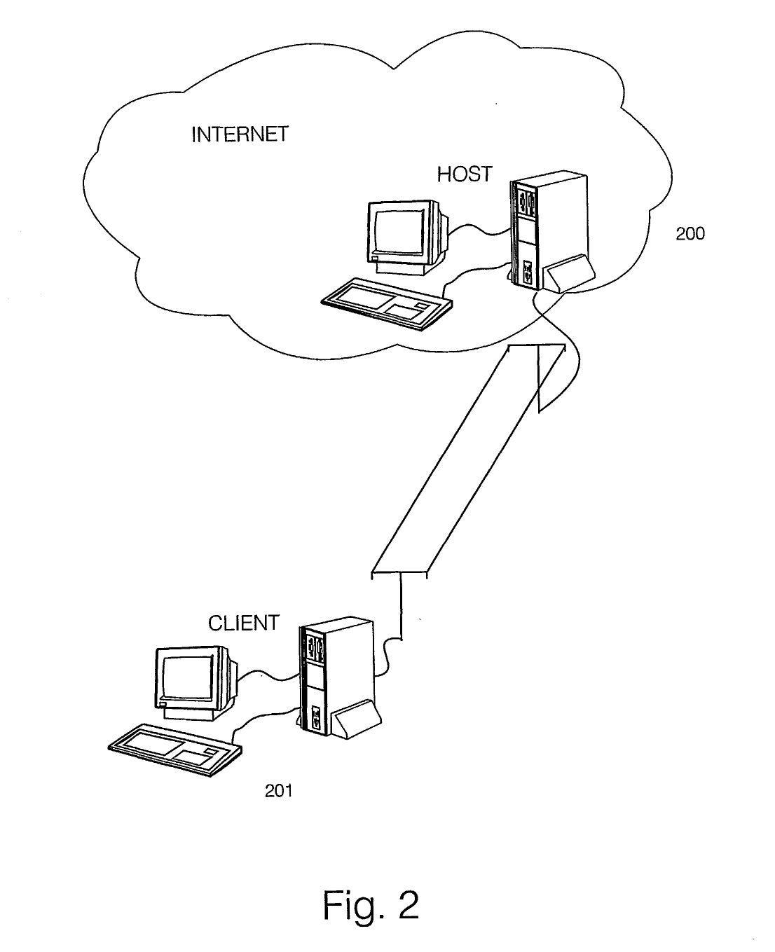

Referring to FIG. 2 herein, there is illustrated schematically individual hardware components comprising client terminal 102 and host server 100, connected by an internet communications link being one of the alternatives for communication between client terminal 102 and host server 100.

Client terminal 102 may comprise a conventional personal computer having a user interface, a keyboard, a modem and internet communications capability. The client terminal 102 comprises a user interface having a visual display unit, keyboard and pointing device to enable monitoring of trade mark applications by an operator, who is preferably a qualified trade mark attorney or qualified trade mark agent.

Similarly, the host server 100 may comprise a conventional computer, having sufficient data processing capability to host a plurality of website displays simultaneously, a modem for connecting the server to the internet for communication with the client terminal 102 and a plurality of said customer terminals, the host server having a user interface for monitoring by an operator comprising a visual display unit, keyboard and pointing device.

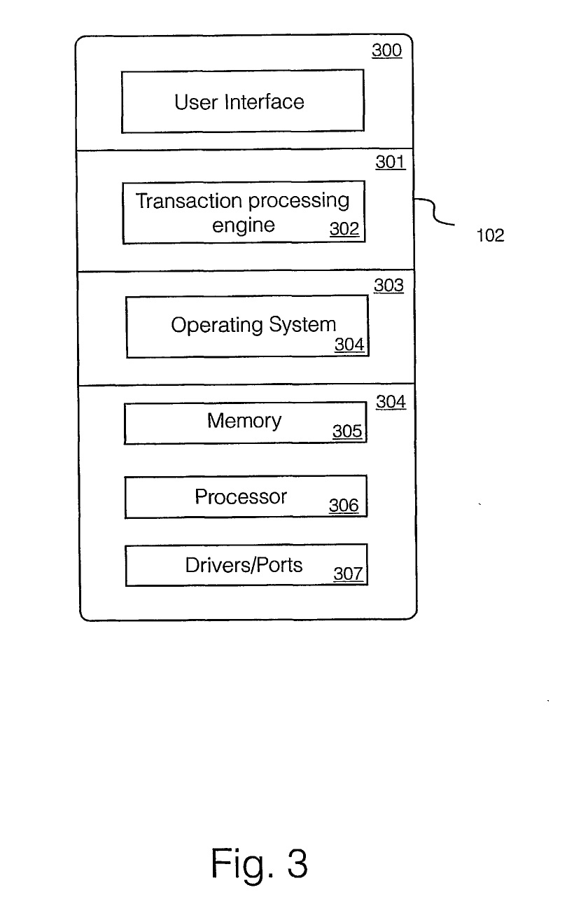

Referring to FIG. 3 herein, there is illustrated schematically components of the client terminal 102. The client terminal 102 comprises an interface layer 300 in which is provided a user interface, the user interface comprising a visual display monitor, a keyboard for data entry and a pointing device, the user interface capable of generating one or more displays for monitoring of trade mark applications being processed by the client terminal 102; a transaction layer 301 comprising a transaction processing engine 302 which operates to send and receive data to and from the host server 100 concerning the filing of trade mark applications; send data to one of more said sub-contractor terminals, send and receive data from one or more said governmental and/or intergovernmental servers 105-107, and communicate with one of more said finance servers 108; an operating system 304, for example the known Windows® 2000 or LINUX® operating systems; and a hardware/firmware layer 305 comprising a one or more processors 306, memory 307 including RAM, ROM and hard disk memory; and a plurality of drivers and ports 308 including CD ROM writers, printer drivers, UBS ports, and one or more modems.

Transaction processing engine 302 uses the underlying operating system and firmware/hardware 305 and user interface 300 to process and manage transactions concerning registration of trade marks, with facilities for interaction and monitoring by a human user.

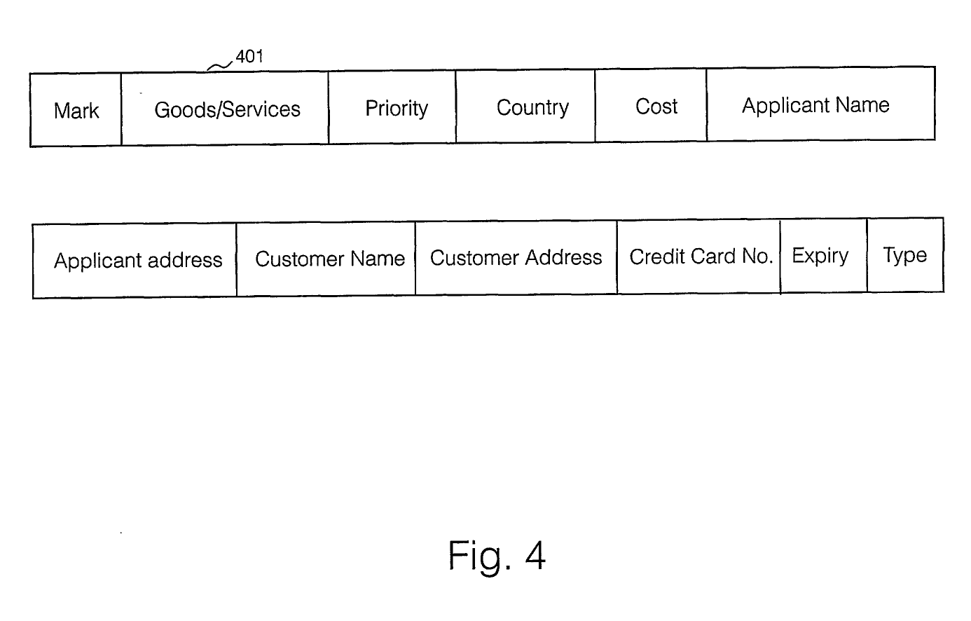

Referring to FIG. 4 herein, there is illustrated schematically a digital signal data received by the client terminal 102 from host server 100 containing the details of a registered trade mark application collected by the host server from a client terminal 201. A digital signal comprises a plurality of data including trade mark data, priority data, and all other types of data as detailed in FIG. 4. In particular, the digital data signal includes data relating to the goods/services 401 with which the users intended trade mark will be associated. The data relating to the goods/services 401 is essential to the on-line trade mark application. Without this data the trade mark application cannot be filed at the relevant international office 106, 107 or 108.

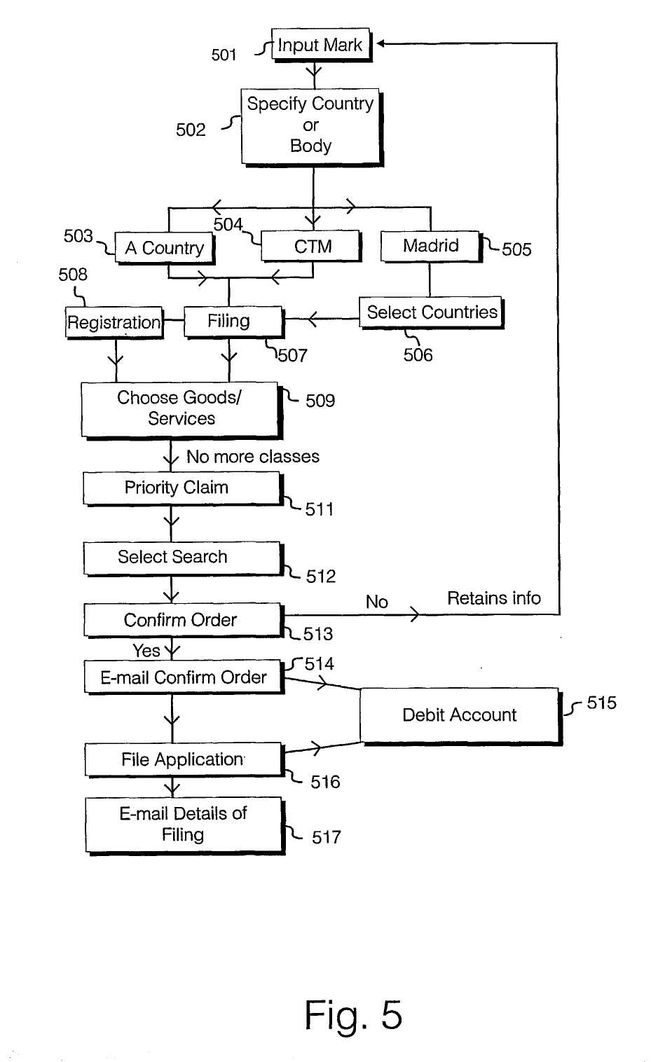

Referring to FIG. 5 herein, there is illustrated schematically a data flow diagram describing flows of data within the system. When filing a trade mark application on-line, the user firstly inputs the details of the intended new proposed trade mark at step 501. The user is then required to specify a country or body at step 502, such that the specifying of a country 503 leads to the filing of a national trade mark application within that particular country. However, the user may alternatively specify the filing of a trade mark application under a body, this body being for example, either a Community trade mark application, or a Madrid Protocol trade mark application, 504, and 505 respectively. If the user selects the Madrid Protocol application 505, he then has to select the countries under the Madrid Protocol system 506. Irrespective of the requirement for a national trade mark application 503 or a Community trade mark application 504 or Madrid Protocol trade mark application 505, the user must specify a requirement of filing 507, and/or an intention to pay the registration fee 508 upon filing.

The user then chooses the goods/services to be associated with the new intended trade mark input at step 509. The choosing of the goods/services at step 509 is by way of the user selecting the goods/services from a predetermined list of goods/services. The presenting and selecting of the goods/services is described in detail below and involves the use of, for example, drop-down menus, scroll bar windows, tick boxes and the highlighting of text. Following the selection of the goods/services 509 from the predetermined list, the user proceeds to indicate any claim to priority 511. The user is then given the choice of selecting a search at 512 to establish if there are any similar or identical marks to his new intended proposed mark. The user then confirms the order at step 513 following the confirmation of details relating to the trade mark application, the system emails the user of the order details at step 514. The fee of a sub-contractor 103 and 104 for the service of filing the trade mark application is debited from the user's account via step 515. The trade mark application is then filed at step 516, the filing details are e-mailed to the user via step 517.

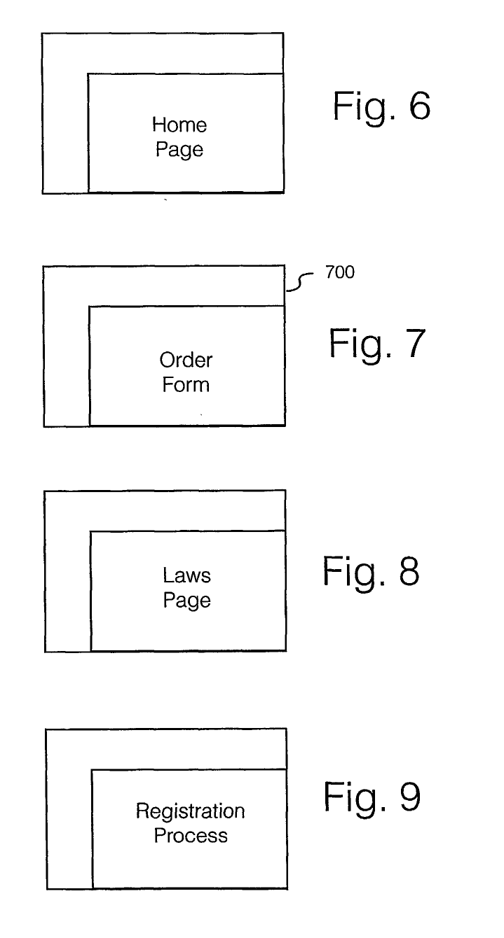

Referring to FIG. 6 herein, there is illustrated a home page comprising part of the website displayed by the service system 102.

Referring to FIG. 7 herein, there is illustrated an order form page comprising part of the website displayed, part of the order form is described in more detail below.

Referring to FIG. 8, there is illustrated a law page comprising part of the website displayed by the service system 102.

Referring to FIG. 9, there is illustrated a registration process page. The registration process page displays data describing a general registration process generic to one or a plurality of countries for obtaining a registered trade mark.

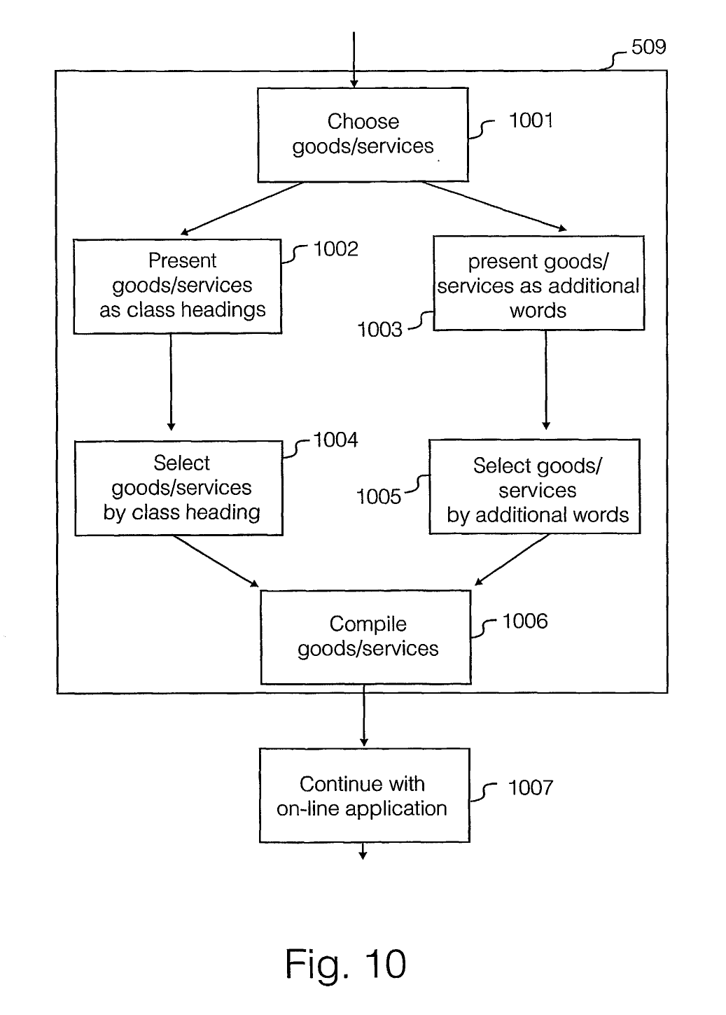

FIG. 10 illustrates a part of the on-line trade mark application procedure whereby the user selects the goods/services 509. As part of the on-line trade mark application the user chooses the goods/services at step 1001. The user is first presented with the goods/services as class headings at step 1002. Additionally, the user is presented with goods/services as additional words at step 1003.

Following the presenting of the goods/services to the user via the user interface 300, the user then proceeds to select the goods/services to be associates with his new intended proposed mark. The selection of the goods/services may be, by way of example, by the class heading at step 1004 and/or the selection of goods/services is by way of the user selecting additional words at step 1005. The selecting of the goods/services by class heading 1004 serves as a general selection of the goods/services. By presenting the user with a predetermined list of words for selection, the user is provided with the facility to considerably tailor the choice of goods/services to more accurately fit his particular requirements. The methods by which the system presents the user with a predetermined list of goods/services is described in detail below. Additionally, the processes by which the user selects the goods/services is described in detail below.

Following the user's selection of the goods/services at steps 1004 and 1005 the system compiles the selected goods/services at step 1006. This compilation stage results in a specification of goods/services to which the new proposed mark will be associated. After the system has compiled the goods/services at stage 1006 using its integral units as described in FIG. 3, the user proceeds to continue completing the order form 700 at step 1007 whereby the user is required to continue the inputting of data as detailed in FIG. 4.

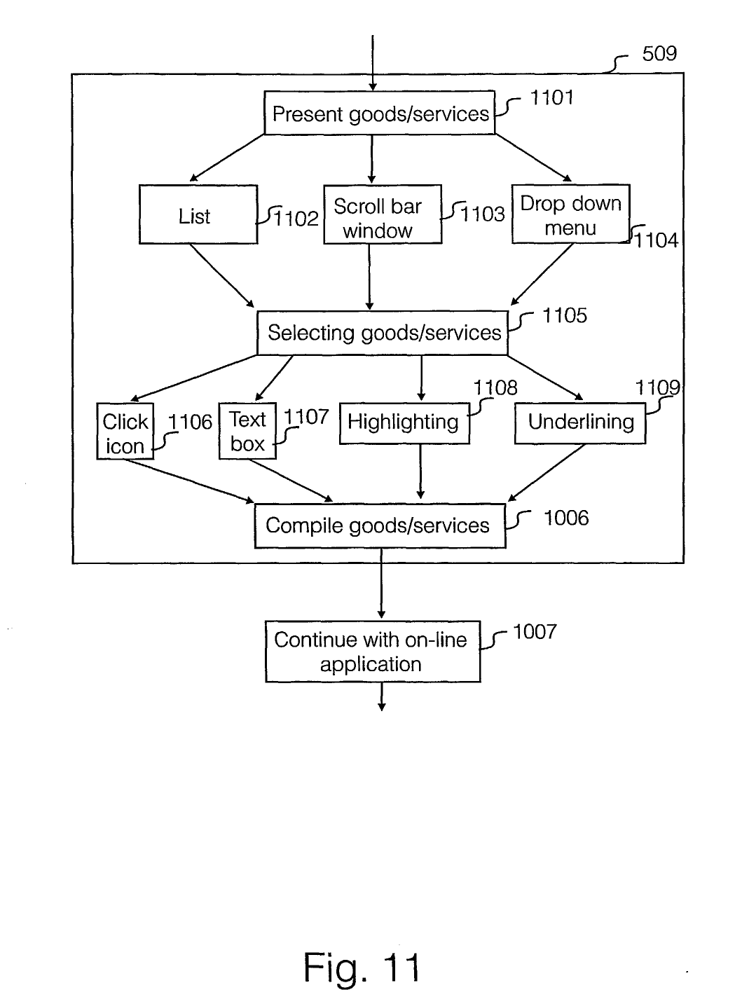

Referring to FIG. 11, there is illustrated a flow diagram detailing the choosing of the goods/services 509 by the user of a system. As detailed above, the user is presented with a predetermined list of goods/services at step 1101. This predetermined list may be presented to the user by way of, for example, a list of goods/services 1102 viewable directly on the order form 700. Alternatively or in addition to, the user may be presented with a predetermined list of goods/services via a suitable scroll bar window 1103. Alternatively, or in addition, the user may be presented with the predetermined list of goods/services via a suitable drop-down menu 1104. The system is configurable such that the predetermined list details the goods/services as class headings, or as additional words, these additional words being more descriptive of the goods/services, thereby providing the user of the system with the facility to specify the goods/services in detail. The system can be configured so as to present the user with any combination of the variations for presenting the goods/services, these being, by way of example, 1102, 1103 and 1104.

As detailed in FIG. 10, following the presentation of the predetermined list of goods/services the user is then required to select the goods/services at step 1105. This selecting step may include the use of, by way of example, clicking an icon 1106, entering characters into a suitable text box 1107, highlighting text 1108 and/or underlining text 1109.

As is generally commonplace with modem computer systems, selecting information via internet websites involves the use of a mouse, this mouse forming part of the client terminal 201. Commonly, the user of an internet website, in general, selects information by controlling a cursor via the operation of the mouse, such that the piece of information or icon which the user wishes to select is partly covered by the cursor. The various modes of selecting the goods/services in steps 1106, 1107, 1108 and/or 1109 are receptive to, and are configured to respond to selection by a cursor which in turn is controlled via a mouse and ultimately operated by a user of the system. The various modes of selecting the goods/services as detailed above can be configured to apply to either the selecting of the goods/services by class heading 1004 and/or the selection of additional words 1005. Following the compilation of goods/services 1006, the user then continues to complete the on-line application form 700 at step 1007.

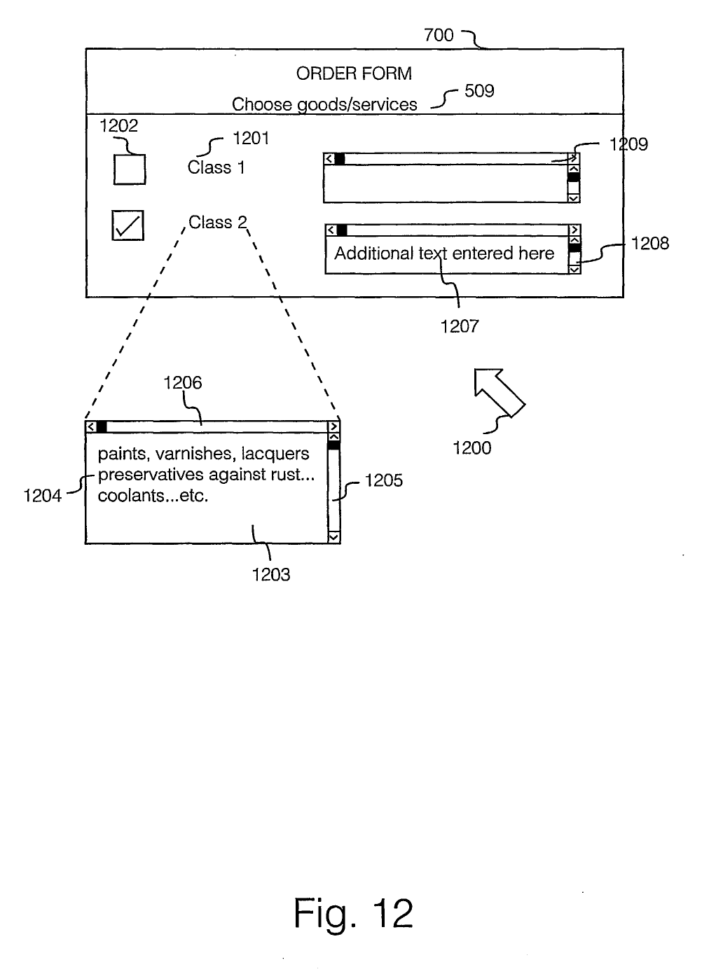

Referring to FIG. 12, there is illustrated part of an order form 700, which allows the user to choose the goods/services 509. In this particular embodiment the user selects the specification of goods/services by moving the cursor 1200 over the relevant class number 1201. When the cursor 1200 is positioned over the class number a scroll bar window is generated 1203. The user of the system can review the class heading within the scroll bar window 1204. The scroll bar window can be configured with both vertical and horizontal scrolling means 1205 and 1206 respectively. After the user has been presented with the class heading via the scroll bar window 1203, the user must select at least one class of goods/services to which his mark will be associated. The selection of a class is made by positioning the cursor 1200 over a suitable box 1202, clicking in such a box is indicated by a tick thereby denoting the selection of a particular class of goods/services. In addition, or alternatively the user may choose to enter additional text within a suitable text box 1207. The user inputs words which relate more specifically to his goods/services. Each class 1201 has an associated text box 1207 such that the user may review a class heading via the scroll bar window 1203 and then proceed to enter additional words for a particular selected class. The text boxes 1207, associated with each class, can be configured with scrolling means both vertically and horizontally 1208 and 1209 respectively.

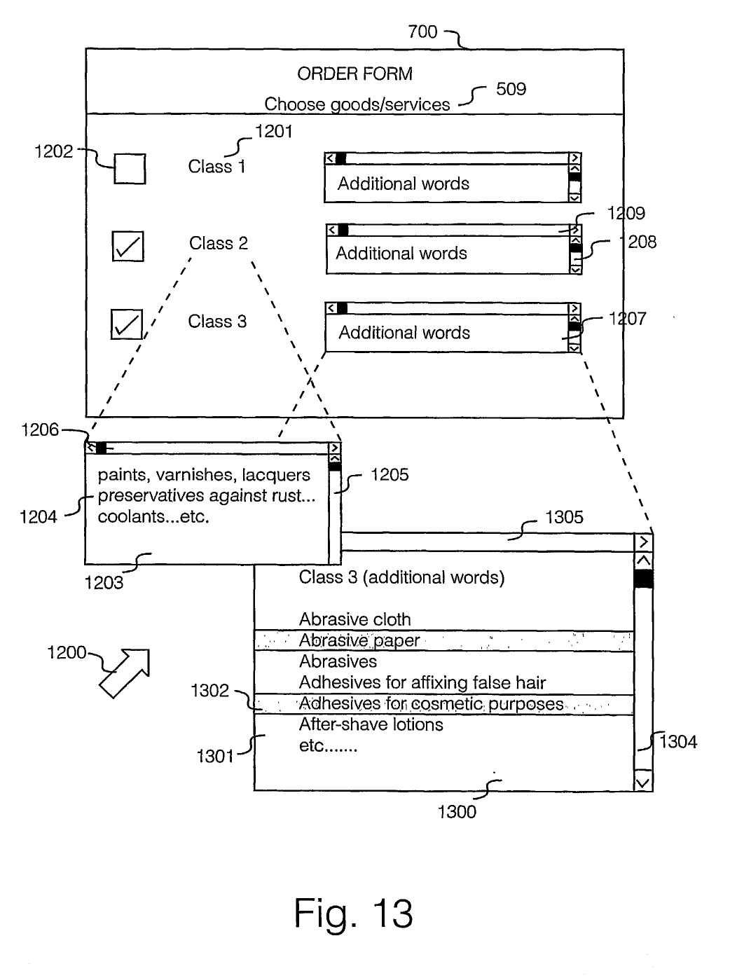

Referring to FIG. 13 herein, there is illustrated part of an order form 700 which allows the user to choose the goods/services 509. In a further embodiment of the present invention the user selects the specification of goods/services by moving the cursor 1200 over the relevant class number 1201. As with previous embodiment, the positioning of the cursor over the class number generates a scrollbar window 1203. The user of the service system then proceeds to review the contents of the scrollbar window 1204 to establish whether to include this particular class in the on-line trade mark application. The selection of a particular class following the review of the class heading by the scrollbar window 1203, is made by positioning the cursor 1200 over a suitable box 1202. The selection of a class is indicated by the appearance of a symbol, in this particular example a tick. As described in the preceding embodiment relating to FIG. 12, additional text relating to a particular class may be specified by the user via a suitable text box 1207. However, in this particular embodiment, the text box 1207 can be configured such that when cursor 1200 is positioned over the text box 1207 a scrollbar window is generated 1300. The contents of scrollbar 1300 detail additional words relating to a particular class of goods/services. Scrollbar window 1300 generated from text box 1207, includes additional words relating to the subject matter contained in the scrollbar window 1203. A user of the system may select such additional words to be included in the specification of goods/services, as shown in FIG. 13 by way of example, by highlighting certain words 1302. Such highlighted words, with respect to unhighlighted words 1301 appear in text box 1207 as constituting selected additional words in respect of class 3, by way of example.

Additionally, the selecting of additional words in relation to a specific class may be indicated by such additional words being, by way of example, underlined, ticked, crossed, changed in color or italicized. Scrollbar window 1300 can be configured with scrolling means 1304 and 1305. Words selected via the scrollbar window 1300 and appearing in text box 1207 may be viewed through the use of a scrolling means 1208 and/or 1209 on the relevant text box window 1207.

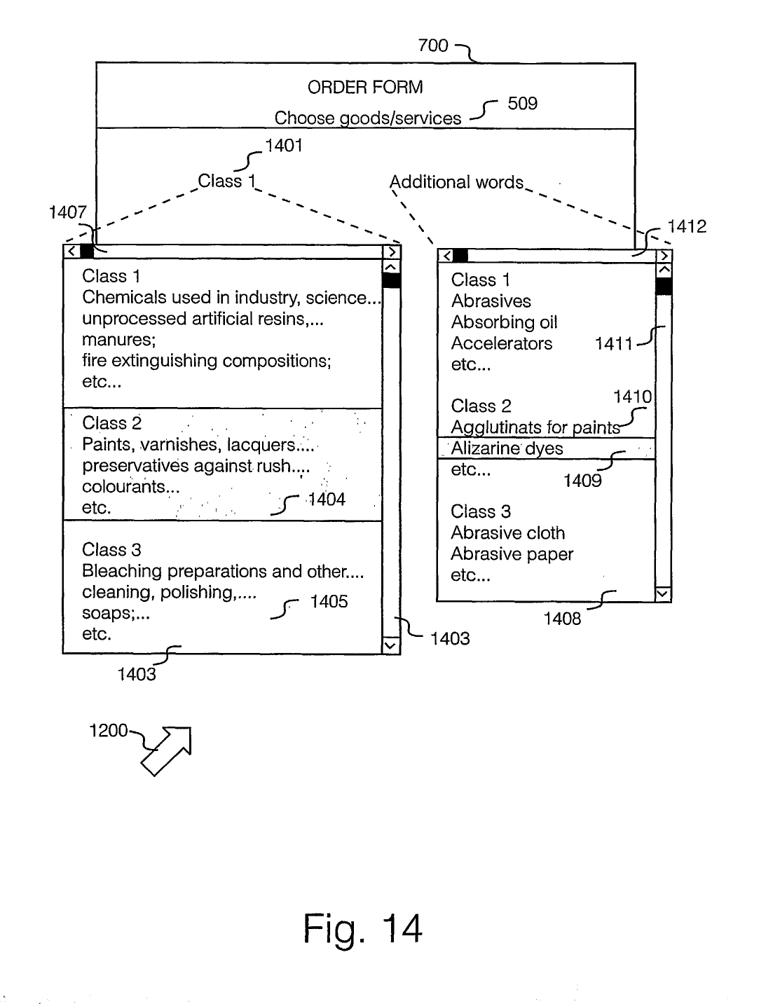

Referring to FIG. 14 there is illustrated schematically a further embodiment of the present invention detailing part of an order form 700, which allows a user to choose the goods/services 509. In this particular embodiment, the user selects the specification of goods/services by moving the icon 1200 over classes 1401 and/or additional words 1402. For example, the positioning of cursor 1200 over classes 1401 generates a scrollbar window 1403 such that the scrollbar window contains all the international class headings (Nice Classification). These class headings are viewable using the vertical and horizontal scrolling means 1406 and 1407 respectively. Having been presented with the list of classes by class headings via the scrollbar window 1403, the user proceeds to select at least one class which will form part of the trade mark application. By way of example, upon selecting the class of classes, via the clicking on the text of the relevant class with the cursor 1200, the selection is denoted by the highlighting of the text 1404. Classes not selected and hence not forming part of the trade mark application remain unchanged 1405. Alternatively, the selecting of a class may be indicated by the text being underlined, ticked, crossed, italicized or the text being configured to change color.

The positioning of the cursor 1200 over additional words 1402 generates a scrollbar window 1408 whereby this scrollbar window details additional words relating to each class of goods/services. A user of the system may review all the additional words relating to each class via the vertical and horizontal scrolling means 1411 and 1412 respectively. Following the presentation of the additional words, the user selects at least one additional word to be included in the trade mark application, such selecting of words being denoted by the highlighted of the words 1409. As described in previous embodiments, means for indicating selection of items from scrollbar windows may be used in this particular embodiment to indicate the selection of additional words. Additional words not highlighted 1410 indicate non-selection and hence are not included in the specification of goods/services forming part of the trade mark application.

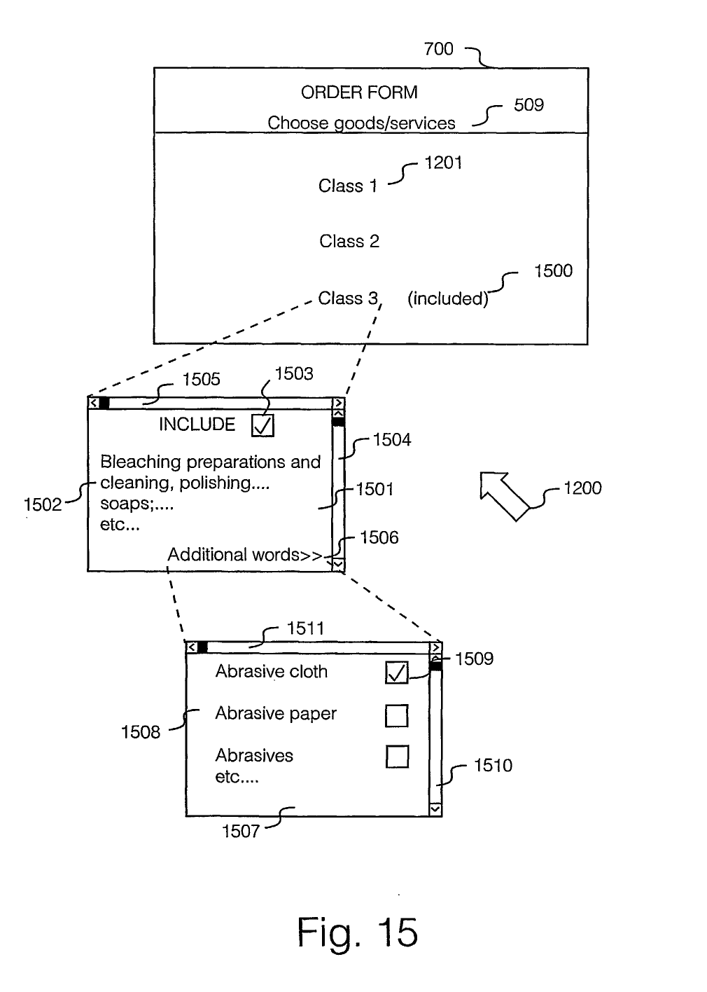

There is illustrated in FIG. 15 a further embodiment of the present invention showing part of an order form 700, which allows a user to choose the goods/services 509. In this particular embodiment the user controls the cursor 1200 via the mouse such that the positioning of cursor 1200 over a class 1201 generates a scrollbar window 1501. The order form 700 is configured such that classes 1 to 42 of the Nice Classification are presented to the user whereby cursor 1200 may be positioned over any class 1 to 42. By way of example, FIG. 15 details the scrollbar window generated through the cursor 1200 being positioned over class 3, whereby the class heading relating to class 3 is displayed 1504. If required, the user may review the entire contents of scrollbar window 1501 via suitable scrolling means 1504 and 1505. Following the review of the class heading 1502, in this case relating to class 3, the user of the system may decide to include this particular class in the specification of goods/services forming part of the on-line trade mark application. The selection of a class is made, by way of example, through the positioning of cursor 1200 over a suitable box such that the clicking in a box 1503 produces the symbol denoting a selection has been made. In this particular embodiment, such a selection is denoted by a tick. Also present within the scrollbar window 1501, in this particular embodiment, is the facility to generate a scrollbar window relating to additional words 1506. The additional words scrollbar window 1507 presents the user with additional words relating to the class number from which the class heading scrollbar window was generated 1501. The user reviews the entire list of additional words 1508 via suitable scrolling means 1510 and 1511. Selection of such additional words may be made, by way of example, through the positioning of cursor 1200 over a suitable box 1509 whereby the clicking in a suitable box produces a symbol indicating a selection has been made. In this case, such a symbol is represented by a tick. However, methods of indicating a selection has been made as described previously in FIGS. 12, 13 and 14 may be applicable to this particular embodiment.

Following the selection of at least one class, by class heading and/or the selection of additional words relating to a particular class number, an indication of selection is through the appearance of a suitable indicator 1500, appearing on part of the order form 700. In this particular example, the word ‘included’ appears adjacent to a class number that has been selected by the user.

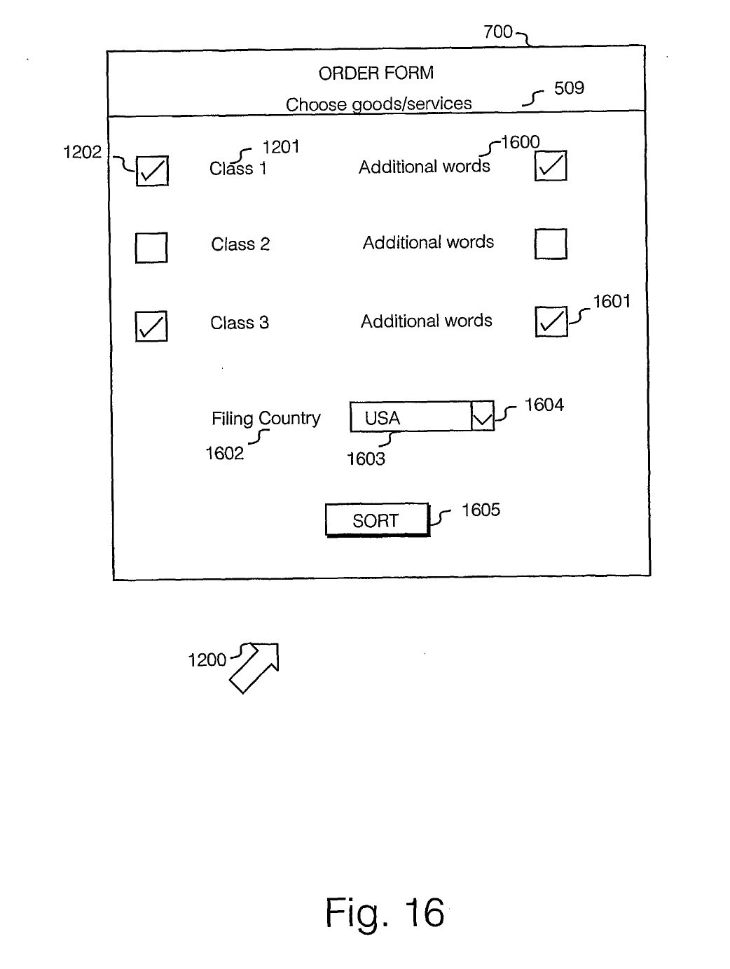

Referring to FIG. 16 there is illustrated one embodiment of a system having an order form 700 such that the order form allows a user to choose goods/services 509. In this particular embodiment, following the selecting of the goods/services, the system is configured to sort the selected goods/services into separate classes. A user of the system selects a class number following the presenting and selecting of the class via suitable presenting and selecting means as described above. In this particular example, the selecting of a class 1201 is indicated by a tick in a box 1202. The inclusion of additional words relating to each class 1600, within the specification of goods/services may be made following the presenting and selecting of additional words using suitable presenting and selecting means as described above. In this particular example, indication of the selection of additional words for a particular class is indicated by a tick within a box 1601.

Following the choosing of the goods/services, via the selecting and presenting means as described above, the system can be configured such that additional words relating to each class of goods/services are compiled. The compiling of specified additional words for a particular class of goods/services is a requirement when, for example, slight variations in the classification system exist between countries. For example, a specific service appearing within class 42 in one country may be indexed slightly different in another country such that this service appears in class 41.

In this particular embodiment, the system is configured to sort the additional words already specified by the user into the relevant class for a particular country. The country in which the trade mark application will be filed (the filing country) 1602 is selected by the user in this particular embodiment, via a suitable dropdown menu 1604. The user then selects the filing country via suitable selecting means such that the filing country is displayed 1603. Via employment of the cursor 1200, the user proceeds to sort the selected additional words 1600, via the icon 1605. The system then proceeds to sort the additional words into the relevant class of goods/services for the particular filing country 1603 as specified by the user 1603.

Presenting and selecting of the classes and additional words in this particular embodiment can be by way of any previously described means for presenting and selecting the goods/services.

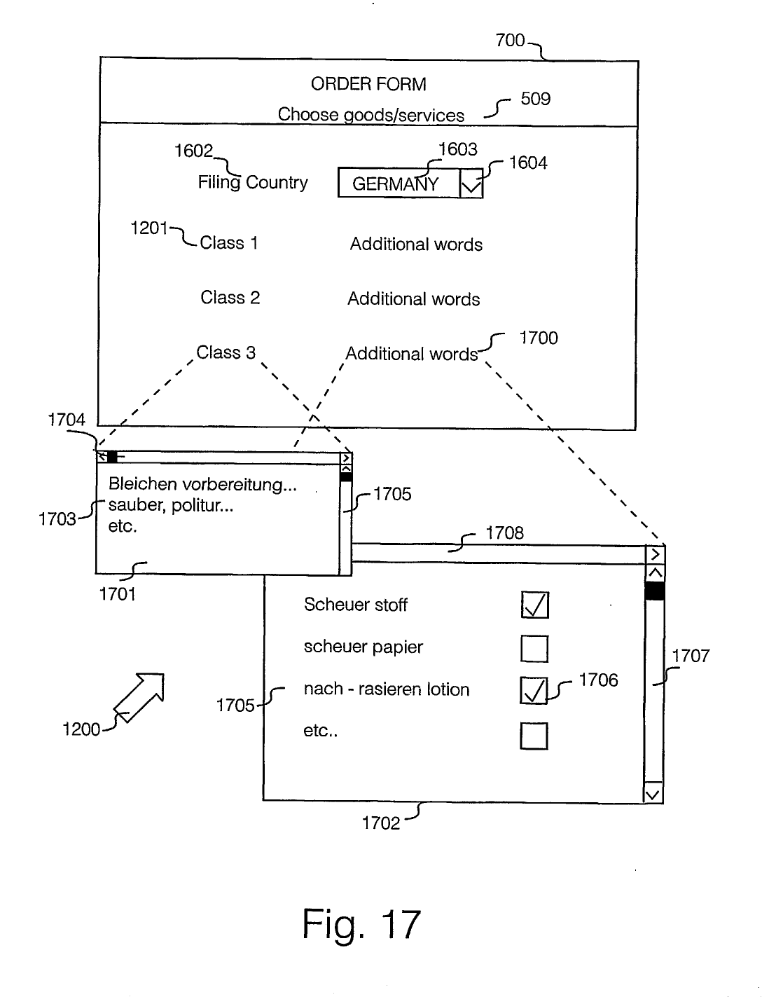

FIG. 17 illustrates part of an order form 700 which allows a user of the system to choose the goods/services 509 to which the new intended mark is to be associated. Given the international nature of the users using the system as described herein, the system can be configured such that the language in which information is presented to a user is selected by a user.

In this particular embodiment, the country in which the trade mark application will be filed, the ‘filing country’ 1602 is selected by the user via a suitable dropdown menu 1604 whereby each country selected by the user is displayed 1603. Following the specification of a country 1603, the order form is then configured to present all information relating to the classes of goods/services and associated additional words in the official language of the country as specified by the user 1603. In this particular embodiment, the cursor 1200 when positioned over a class number 1201 or associated additional words 1700 generates suitable scrollbar windows 1701 and 1702 respectively. It can be seen in this particular embodiment that, by way of example, the class heading of class 3 1703 is shown in the German language as is appropriate for the filing of an application in Germany 1603. As described previously, the scrollbar window is configured with suitable scrolling means 1704 and 1705.

Similarly, additional words relating to class 3, shown by way of example, 1705 are also in German. The selection of additional words can be by way of any suitable selection means as described previously, shown here in FIG. 17, by way of a tick in a box 1706. Scrollbar window can be configured with suitable scrolling means 1707 and 1708.

The presenting of information in the language of the filing country 1603 can be by way of any presenting means as described above.

1. An internet based system configurable to allow a user to file at least one trade mark application said system comprising:
means for presenting a predetermined list of goods/services to said user of said service system; and
means for selecting said goods/services from said predetermined list.

2. An internet based system as claimed in claim 1 wherein said means for presenting said goods/services comprises use of at least one drop down menu.

3. An internet based system as claimed in claim 1 or 2, wherein said means for presenting said goods/services comprises use of at least one scroll bar window.

4. An internet based system as claimed in any of the preceding claims, wherein said means for selecting said goods/services comprises use of at least one icon, whereby said user of said system selects said goods/services via selection of said icon.

5. An internet based system as claimed in any one of the preceding claims, wherein said means for selecting said goods/services comprises use of at least one box, whereby said user of said system selects said goods/services via selection of said box.

6. An internet based system as claimed in any one of the preceding claims, wherein said means for selecting said goods/services comprises use of at least one text box, whereby said user of said system selects said goods/services via the entry of characters into said text box.

7. An internet based system as claimed in any one of the preceding claims, wherein said means for selecting said goods/services comprises highlighting, whereby said user of said system selects said goods/services by highlighting said goods/services.

8. An internet based system as claimed in any one of the preceding claims, wherein said means for selecting said goods/services comprises underlining means, whereby said user of said system selects said goods/services by underlining said goods/services.

9. A method of presenting and selecting goods/services; said goods/services forming part of a trade mark application, said trade mark application being made via an internet based system; comprising the steps of:
presenting a predetermined list of said goods/services to a user of said system; selecting said goods/services from said predetermined list.

10. A method of presenting and selecting goods/services as claimed in claim 9, further comprising the steps of:
present said predetermined list of said goods/services as:
class headings; and
additional words.

11. A method of presenting and selecting goods/services as claimed in claim 9 or 10, further comprising the steps of:
presenting said predetermined list of said goods/services using at least one drop down menu.

12. A method of presenting and selecting goods/services as claimed in any one of claims 9 to 11, further comprising the steps of:
presenting said predetermined list of said goods/services using at least one scroll bar window.

13. A method of presenting and selecting goods/services as claimed in any one of claims 9 to 12, further comprising the steps of:
selecting said goods/services from said predetermined list using:
at least one icon; or
at least one box; or
at least one text box.

14. A method of presenting and selecting goods/services as claimed in any one of claims 9 to 13, further comprising the steps of:
selecting said goods/services from said predetermined list by way of highlighting said goods/services; or
underlining said goods/services.

15. A method of presenting and selecting goods/services as claimed in any one of claims 9 to 14, further comprising the steps of:
presenting said goods/services as class headings using a scrollbar window;
selecting said goods/services;
entering additional words within a suitable text box.

16. A method of presenting and selecting goods/services as claimed in any one of claims 9 to 15, further comprising the steps of:
presenting said goods/services as class headings using a suitable scrollbar window;
presenting additional words to said user of said system using a scrollbar window;
selecting said additional words by highlighting said additional words.

17. A method of presenting and selecting goods/services as claimed in any one of claims 9 to 16, further comprising the steps of:
presenting said goods/services as class headings using a scrollbar window;
presenting additional words of said goods/services using a scrollbar window;
selecting said class headings and said additional words by highlighting said class headings and said additional words.

18. A method of presenting and selecting goods/services as claimed in any one of claims 9 to 17, further comprising the steps of:
presenting said goods/services as class headings using a first scrollbar window;
presenting additional words of said goods/services using a second scrollbar window, said second scrollbar window being generated from said first scrollbar window.

19. A method of presenting and selecting goods/services as claimed in any one of claims 9 to 18, further comprising the steps of:
sorting said goods/services into the relevant classes following the presenting and selecting of said goods/services.

20. A method of presenting and selecting goods/services as claimed in any one of claims 9 to 19, further comprising the steps of:
specifying a country in which said trade mark application will be filed;
presenting said goods/services as class headings using a first scrollbar window;
presenting additional words of said goods/services using a second scrollbar window;
said presenting of said goods/services being in the official language of said country in which said trade mark application will be filed.

21. A user interface for generating an interactive display capable of receiving instructions for selection of individual goods/services, said user interface comprising:
a plurality of class selection icons for selecting at least one class of goods/services;
wherein said user interface is capable of receiving said instructions by selection of a said class selection icon.

22. The user interface as claimed in claim 21, further comprising:
at least one dialogue box for containing a list of individual goods/services by name,
wherein said user interface is capable of receiving said instructions by activation of individual text data within said text dialogue box.

23. The user interface as claimed in claim 21 or 22, further comprising a dialogue box data entry display, for entering text descriptions of goods/services not listed in said goods/services menu.

24. The user interface as claimed in any one of claims 21 to 23, wherein said menu dialogue lists a generic text description of goods/services corresponding to a class icon.

25. The user interface as claimed in any one of claims 21 to 24, further comprising:
a country selection icon capable of receiving instructions for selecting a country wherein,
upon entering a country code corresponding to a particular country, said goods/services are displayed in a language appropriate to said selected country.

26. A remotely accessible user interface for generating an interactive display capable of receiving instructions for selection of individual goods/services, said user interface comprising:
at least one data processor;
at least one memory storing instructions for operating said data processor;
at least one memory for storing data describing a plurality of individual countries, and text descriptions of classifications of goods/services;
said user interface configured to display:
a plurality of class selection icons for selecting at least one class of goods/services;
a menu display, listing a generic text description of goods/services corresponding to a said class icon.
at least one dialogue box display for entering text descriptions of goods/services;
wherein said user interface is capable of receiving instructions for selection of at least one class of goods/services by activating a said icon selecting said at least one class of goods/services.

27. A method of operation of a user interface for receiving instructions for selection of individual goods/services, said method comprising:
generating an interactive display of a plurality of class icons, each representing a class of goods/services;
selecting at least one class of goods/ services by activating at least one said class selection icon.

28. The method as claimed in claim 27, further comprising the steps of:
generating at least one text menu dialogue box containing a list of individual goods/services by name; and
receiving said instructions by activation of individual text data within said text dialogue box.

29. The method as claimed in claim 28, wherein said menu dialogue lists a generic text description of goods/services corresponding to a class icon.

30. The method as claimed in any one of claims 27 to 29, further comprising the steps of:
generating a dialogue box data entry display, for entering text descriptions of goods/services not listed in said goods/services menu.

31. The method as claimed in any one of the claims 27 to 30, further comprising the steps of:
generating a country selection icon capable of receiving instructions for selecting a country,
receiving instructions for selecting a country, by selection of said country selection icon; and
upon entering a country code corresponding to a particular country, displaying said goods/services in a language appropriate to said selected country.

32. A method of operation of a remotely accessible user interface for generating an interactive display capable of receiving instructions for selection of individual goods/services, said user interface comprising:
at least one data processor;
at least one memory storing instructions for operating said data processor; and
at least one memory for storing data describing a plurality of individual countries, and text descriptions of classifications of goods/services;
said method comprising the steps of:
displaying a plurality of class selection icons for selecting at least one class of goods/services;.
displaying a menu dialogue, listing a generic text description of goods/services corresponding to a said class selection icon;
displaying at least one dialogue box display for entering text descriptions of goods/services;
receiving instructions for selection of at least one class of goods/services by activating a said class selection icon selecting said at least one class of goods/services; and
receiving instructions for selection of individual goods/services by receiving text descriptions of said goods/services entered via a said dialogue box display for entering text.
